(19) United States
(12) Patent Application Publication
(10) Pub. No.: US 2009/0132333 A1
(43) Pub. Date: May 21, 2009

(54) OPTION EXCHANGE FOR COMPONENTS

(76) Inventors: Uri Sheffer, Tel Aviv (IL); Zvi Weber, Reut (IL); Dafna Levy Philosoph, Tel Mond (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/940,356

(22) Filed: Nov. 15, 2007

(51) Int. Cl. G06Q 30/00; G06F 19/00; G06Q 10/00

(52) U.S. Cl. 705/10; 705/27

(57) ABSTRACT

An application runs on a computer system of a computer network operative between a supplier and a customer. The supplier provides components used for manufacturing or resale by the customer. The application includes an interface to an enterprise resource planning (ERP) system of the supplier and receives as input from the ERP a predicted capacity of the supplier for supplying the components. A computerized exchange is attached to the application. Based on the predicted capacity, the supplier, using the application, issues options on the computerized exchange. The options are for buying the components in the future by the customer. Each option includes: (i) expiration date for exercising the option by the customer, (ii) an strike price for the buying of a specific quantity of the components; and (iii) a lead time for delivery of the specific quantity of the components. The lead time is specified relative to the exercise date. A management module preferably inputs into the application a predicted probability of the exercising by the customer. The computer network, preferably sets an ask price and number of the options issued based on the predicted probability of the exercising.

### FIELD AND BACKGROUND OF THE INVENTION

The present invention relates to financial instruments and more particularly a novel exchange-traded instrument and exchange thereof, the instrument being an option on a future or forward contract for delivery of raw materials and/or components used in a manufacturing process at specified lead times after exercising the option.

Options of the prior art are financial instruments that convey the right, but not the obligation, to engage in a future transaction on some underlying security. For example, buying a call option provides the right to buy a specified amount of a security at a set strike price at some time on or before expiration, while buying a put option provides the right to sell. Upon the option holder's choice to exercise the option, the party that sold, or wrote, the option must fulfill the terms of the contract.

Exchange-traded options have standardized contract features and trade on public exchanges, facilitating trading among independent parties. Over-the-counter options are traded between private parties, often well-capitalized institutions, that have negotiated separate trading and clearing arrangements with each other.

In many cases, options are traded on futures. A put option is the option to sell a futures contract, and a call option is the option to buy a futures contract. For both, the option strike price is the specified futures price at which the future is traded if the option is exercised. Ask price, also called offer price, offer, or simply ask, is a price a seller of a good is willing to accept for that particular option. Bid price is a price a buyer offers for a particular option. The difference between the ask price and the bid price is called the spread.

While futures and forward contracts are both a contract to deliver a commodity on a future date at a prearranged price, they are different in several respects: Forward contracts transact when purchased on the settlement date. Futures, on the other hand, are rebalanced, or “marked-to-market”, everyday to the daily spot price of a forward contract with the same agreed-upon delivery price and underlying asset. The lack of rebalancing of forward contracts means that, in some cases, due to movements in the underlying's price, a large differential will build up between the forward contract delivery price and the settlement price. This means that one party will incur a big loss at the time of delivery (assuming they must transact at the underlying's spot price to facilitate receipt/delivery). This in turn creates a credit risk. More generally, the risk of a forward contract is that the supplier will be unable to deliver the required commodity, or that the buyer will be unable to pay for it on the delivery day.

The rebalancing of future contracts eliminates much of this credit risk by forcing the holders to update daily to the price of an equivalent forward purchased that day.

Enterprise Resource Planning (ERP) is a term originally derived from manufacturing resource planning systems (MRP II) which developed from material requirements planning (MRP) systems. ERP systems typically handle the manufacturing, logistics, distribution, inventory, shipping, invoicing, and accounting for a company. Enterprise Resource Planning or ERP software can aid in the control of many business activities, like sales, marketing, delivery, billing, production, inventory management, quality management, and human resource management Examples of modules in an ERP which formerly would have been stand-alone applications include: Manufacturing, Supply Chain, Financials, Customer Relationship Management (CRM), Human Resources, Warehouse Management and Decision Support System.

Manufacturing and production rely on components and raw materials used in the manufacturing and production processes. In some cases the components and/or raw materials required for manufacture are long-lead items with a volatile price and uncertain future availability in the quantities required. In order to cope with these uncertainties, long term sales forecasts are given to the suppliers to indicate expected requirements in terms of quantities and delivery times for the raw materials and components. After providing suppliers with the expected quantities, orders are placed by the manufacturers with the suppliers using future or forward contracts in which the orders are placed and the products are delivered before one or more known later dates with a previously defined price. In some cases, a large inventory needs to be maintained in order to insure supply of critical items or to hedge against a significant rise in price.

Typically, as time passes the sales forecast on which the futures or forward contracts are based turns out to be inaccurate, either an underestimation or an overestimation of the actual sales. An underestimation of sales forecast typically results in insufficient inventory of certain items of the parts list of manufactured items for which delivery has been promised. Typically, critical items of the parts list are available at a high price or are completely unavailable using the normal supply channels. The purchase department then needs to improvise with an ad hoc purchase at a high cost from stocking distributors or even from other manufacturers who may have extra inventory of the missing critical items. In some cases, engineering departments are requested to qualify alternative parts which may compromise quality. An overestimation of sales forecasts, has an adverse impact on cash flow and often results in “dead” inventory if the manufactured item is, revised or discontinued. Dead inventory can be sometimes be sold to specific dealers, however, at compromised prices.

There is thus a need for, and it would be highly advantageous to have an exchange of options for buying and selling components and/or materials required for manufacturing processes and an exchange for trading this options.

### SUMMARY OF THE INVENTION

The term “customer” as used herein is a customer of a supplier of the raw materials and/or components for use in manufacturing and/or production of goods for sale. Typically, the “customer” is a manufacturer, a distributor, or otherwise a reseller of the goods. The term “application” as used herein is a computer application as in computer program or software.

The term “expiration date” as used herein is an absolute date or a date specified as a previously defined period of time subsequent to a trigger date or event. An “expiration date” may be set for example, three months subsequent to the opening date of a new production line. According to the present invention there is provided a computer network operative between a supplier and a customer. The supplier provides components used for manufacturing or resale by the customer. An application runs on a computer system of the computer network. The application includes an interface to an enterprise resource planning (ERP) system of the supplier and receives as input from the ERP a predicted capacity of the supplier for supplying the components. A computerized exchange is attached to the application. Based on the predicted capacity, the supplier, using the application, issues options on the computerized exchange. The options are for buying the components in the future by the customer. Each option includes: (i) an expiration date for exercising the option by the customer, (ii) a strike price for the buying of a specific quantity of the components; and (iii) a lead time for delivery of the specific quantity of the components. The lead time is specified relative to the exercise date. A management module preferably inputs into the application a predicted probability of the exercising by the customer. The application, preferably sets the number of the options issued based on the predicted probability of the exercising.

An interface preferably connects between the computerized exchange to an ERP system of the customer. When ERP system of the customer predicts a future excess inventory of a component, the customer either offers for sale options on the computerized exchange, or the supplier issues new options of a second type for buying back by the supplier from the customer at least some of the components.

The computerized exchange is preferably connected (by an interface) to an ERP system of the customer. The application receives from the ERP system of the customer as input predicted purchasing requirements of the components. The application searches through the options and provides based on the purchase requirements specific options for bid by the customer.

According to the present invention there is provided, a method of doing business between a supplier and a customer. The supplier provides components used for manufacturing or resale by the customer. An enterprise resource planning (ERP) system of the supplier is connected to and receives as input from the ERP a predicted capacity of the supplier for supplying the components. Based on the predicted capacity, options are issued by the supplier on an option exchange. The options are for buying the components in the future by the customer. Each option includes: (i) a expiration date for exercising the option by the customer, (ii) a strike price for the buying of a specific quantity of the components; and (iii) a lead time for delivery of the specific quantity of the components. The lead time is specified relative to the exercise date. A predicted probability of the exercising is preferably input into the application. A predicted probability of the exercising and the number of options is preferably input into the ERP of the supplier. The number of options issued is preferably set based on the predicted probability of the exercising; or a parameter, (e.g. expiration date and/or lead time) of the options is set based on the predicted probability of the exercising. When the options are included in one or more series of options, the application upon issuing the series, sets based on the predicted probability a parameter of the series, e.g. expiration date an lead time. The computer network preferably includes an interface between the computerized exchange and an enterprise resource planning (ERP) system of the customer. When the ERP system of the customer predicts a future excess inventory of the components, the customer optionally offers for sale one or more of the options on the computerized exchange or an option of a second type is issued by the supplier for buying back at least some of the components from the customer. The application preferably receives from the ERP system of the customer a predicted purchasing requirement for purchasing the components are preferably received, the application searches through the options; and provides based on the purchase requirement specific options for bid by the customer.

According to the present invention there is provided a computer readable medium readable by a computer, tangibly embodying a program of instructions executable by the computer to perform a method of doing business between a supplier and at least one customer, wherein the supplier provides components used for manufacturing or resale by the at least one customer, the method steps as disclosed herein.

### BRIEF DESCRIPTION OF THE DRAWINGS

The invention is herein described, by way of example only, with reference to the accompanying drawings, wherein:

FIG. 1 is a drawing of a computer network including an option exchange, according to embodiments of the present invention;

FIG. 2 illustrates the life cycle of options issued and traded using the exchange according to embodiments of the present invention;

FIG. 3 illustrates interactions between the manufacturer ERP and the application engine, according to an embodiment of the present invention;

FIG. 4 illustrates interactions between the supplier ERP and the application engine, according to an embodiment of the present invention;

FIG. 4a is a graph of production capacity which illustrates utility of embodiments of the present invention;

FIG. 5 is a drawing which illustrates interactions between the application engine with a management module and an exchange according to an embodiment of the present invention; and

FIG. 6 is a flow drawing of a method of issuing options according to an embodiment of the present invention.

### DESCRIPTION OF THE PREFERRED EMBODIMENTS

The present invention relates to tradable options, a method of trading the options and an exchange for trading the options. The options are for buying and selling underlying lead-time, non commodity components and/or raw materials, and/or resources (e.g. production resources, services, manpower) typically with a highly volatile cost. The issue of the options and trade of the options, according to embodiments of the present invention are preferably implemented using applications installed and running in one or more computer systems connected by a data communications network.

The principles and operation of a tradable option, a method of trading the options and exchange for trading the options, according to embodiments of the present invention, may be better understood with reference to the drawings and the accompanying description.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

It should be noted, that although the discussion herein relates for the sake of improved clarity to a customer which is a manufacturer, the present invention may, by non-limiting example, alternatively be configured as well with a distributor or reseller who are customers of the supplier.

By way of introduction, the principal intention of the present invention is to facilitate the logistical requirements of suppliers and manufacturers by providing an environment to purchase and sell options for components, raw materials and/or resource. The options are issued by the supplier for raw materials and/or components at a specified price and a delivery time specified as a lead time after the options are exercised. For example, supplier Yntel has ongoing future or forward contracts with YBM to sell integrated circuits. Instead of or in addition to a future or forward contract between the two parties. Yntel as supplier issues options for five million microprocessor integrated circuits, the options tradable on a computerized exchange, according to embodiments of the present invention. Typically, a supplier, e.g. YNTEL issues a series of options each with a previously defined quantity of components specified in each issued option, each with a lead time for delivery specified after exercise of the issued option and an ask price for purchasing each option. YBM using the exchange, bids for and acquires options for 500,000 microprocessor integrated circuits. The options include a standard delivery and payment arrangement, for instance with delivery starting 90 days after the options are exercised and payment within 120 days after each delivery. According to further features of the present invention, the manufacturer, e.g. YBM may have “dead stock” of microprocessors or anticipates having dead stock in the near future (perhaps after Yntel announced a new release of the microprocessor). YBM may offer (on the exchange of the present invention) to sell options held from YNTEL for e.g. 225,000 microprocessors with the delivery and payment terms as stated in the issued options or issue new options to sell the 225,000 microprocessors with different payment terms, i.e. cost and lead time after exercise. The quantity of components in each option is typically predefined for each specific component traded in the exchange.

According to embodiments of the present invention, there are many parameters that are passed back (output) to the ERP system of the supplier. As a result of the mechanism which determines how many options will be sold and exercised, the supplier has to make all necessary preparations for the actual orders. The application preferably provides probabilistically to the supplier with numbers of components to be supplied at various times.

Series optionally form a framework for bundling specific options with similar characteristics. A series of options may be viewed as a rows of table, each row including a unique identifier of the underlying asset (the component), a specific expiration date and a lead-time. Anyone addressing a specific series will knows that offering for the options with the underlying component expires at the stated expiry date and with a given delivery time from exercising of the options. Within each series, rows of the table further identify specific options; at each row, one might trade options for the specific component, expiry date, and lead-time—as typically depicted by the series itself but typically with a given strike price for all rows of the option. Under the specific series set parameters, one can choose an option by its strike price—the price later paid for the actual components upon delivery of the components. Series that are created with predefined expiration date and lead time typically cannot be changed later by the application. Furthermore, the strike prices of options within a series preferably cannot be changed after issue of the options. The application can typically change the number of options that were allocated to a specific series and the way they are divided among the strike prices within the series—as long as they are outstanding (i.e. still not sold to any customer).

The exchange for trading options, according to embodiments of the present invention is preferably integrated with the ERP systems of the supplier and/or manufacturer. On the supplier, e.g. YNTEL, side, for instance, a predicted capacity for supplying microprocessors is provided by YNTEL's ERP system in addition to operations cost and current availability information. The predicted capacity is used to determine the quantity of underlying components for which to list new options on the exchange. Cost and availability information available from the ERP is used to determine the terms of the listed options. An algorithm is used to determine a predicted level of exercise (PLOE) of the options. The predicted level of exercise (PLOE) is input periodically to adjust the quantity of underlying components for which to list new options on the exchange.

In embodiment of the present invention, options of a second type, may be traded. The supplier buys back actual components from its customers. The supplier (and typically only the supplier) issues an option which represents a given demand for a component by the supplier. The option entitles its purchaser the ability to sell back to the supplier a certain component (the underlying asset) originally bought from that supplier (or a reseller) and still in its original package, at a given set price strike price), and the options are valid only through a finite date in the future (expiration date). When the purchaser exercises an option of the second type, the purchased preferably delivers the components immediately back to the supplier at a zero lead-time.
the application at the computerized network receives as an external parameter (input) “. . . a predicted capacity of the supplier for supplying the components . . .” As a result, options are issued; customers purchase and exercise the options thereby creating actual sales and deliveries of the underlying component.

The embodiments of the present invention may comprise a general-purpose or special-purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “network” is defined as any architecture where two or more computer systems may exchange data. Exchanged data may be in the form of electrical signals that are meaningful to the two or more computer systems. When data is transferred or provided over a network or another communications connection (either hardwired, wireless, or a combination of hardwired or wireless) to a computer system or computer device, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions.

In this description and in the following claims, a “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone or Personal Digital Assistant “PDA”) where internal modules (such as a memory and processor) work together to perform operations on electronic data.

Those skilled in the art will appreciate that the invention may be practiced in network computing environments with many types of computer system configurations: network PCs, minicomputers, mainframe computers, and the like. The invention may also be practiced in distributed computing environments where local and remote computer systems, which are linked (either by hardwired links, wireless links, or by a combination of hardwired or wireless links) through a communication network, both perform tasks. In a distributed computing environment, program modules may be located in both local and remote memory storage devices.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software selected steps of the invention could be implemented as a plurality of software instructions being executed by a computer using any suitable operating system. In any case, selected steps of the method and system of the invention could be described as being performed by a data processor, such as a computing platform for executing a plurality of instructions.

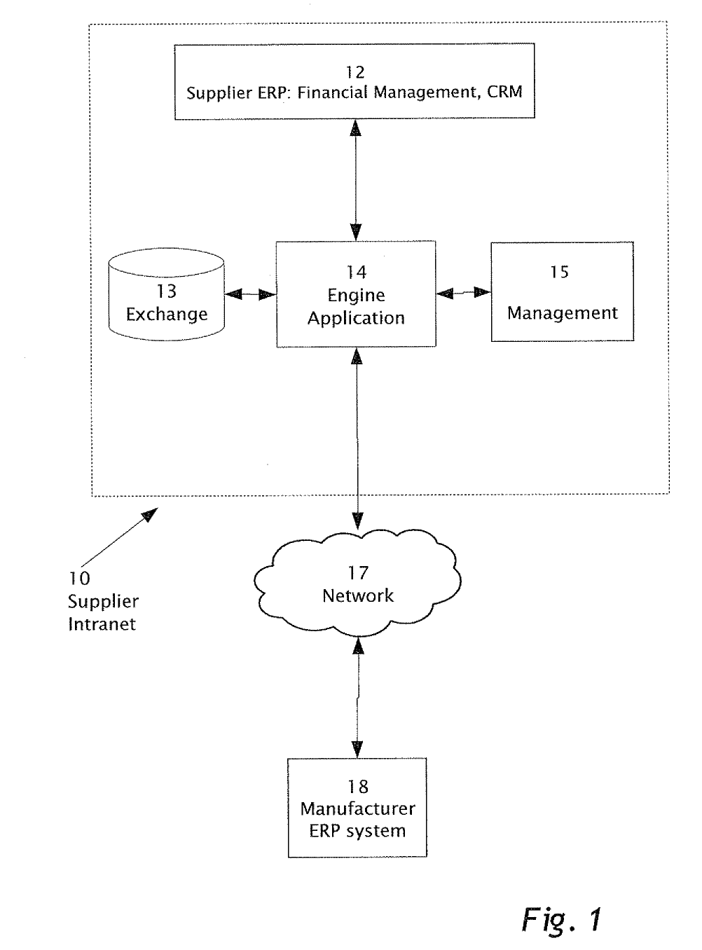

Referring now to the drawings, FIG. 1 illustrates a network 10 typically a local area network (LAN) or virtual private network (VPN) of a supplier, including an ERP system 12 of the supplier connected over a wide area network, e.g. Internet 17 to an ERP system 18 of a manufacturer. The manufacturer typically purchases components and/or raw materials from the supplier for use in product manufacture. The connection between the ERP system 12 of the supplier and ERP system 18 of the manufacturer is through an engine application 14 preferably installed on one or more computers systems of supplier network 10. Engine application 14 is operative for trading in options, according to the present invention; the options are for purchase of the components produced by the supplier and used in manufacturing by the manufacturer. Engine application 14 connects to an exchange 13 which includes storage of records of the current status of the options currently listed and traded. A management module 15 is used for accessing engine application 14 by the supplier.

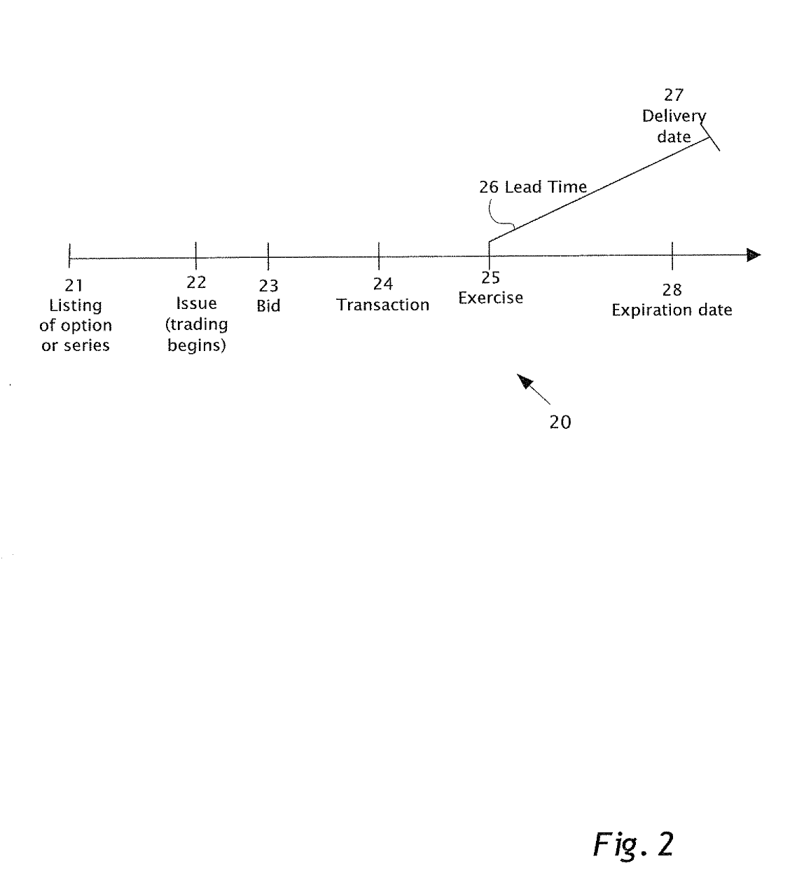

Reference is now made to FIG. 2 which illustrates a life cycle 20 of options tradable on exchange 13, according to embodiments of the present invention. Life cycle 20 begins with a listing 21 of an option or a series of options. Listing 21 is preferably performed by storing an appropriate record in exchange 13 by application 14. Listing 21 includes information specifying the underlying components, e.g. microprocessor YNTEL Model 2345, a quantity, e.g. 5000, microprocessors, a future issue date 22 which specifies when trading will begin, a strike price for the quantity of microprocessors, an expiration date 28—a final date for exercise of the option, and a lead time 26 after actual exercise (step 25) of the option which specifies a delivery date 27 of the components. After issue date 22, different customers have an opportunity to bid 23 for the option. The option is typically purchased during transaction (step 24) by the highest bidder. If the customer holding the option chooses to exercise (step 25) the option, a future contract results with a lead time 26 and delivery date 27 as specified during listing (step 21) of the option. If the supplier who holds the option chooses not to exercise the option before the final date of exercise, then the option expires on an expiration date 28.

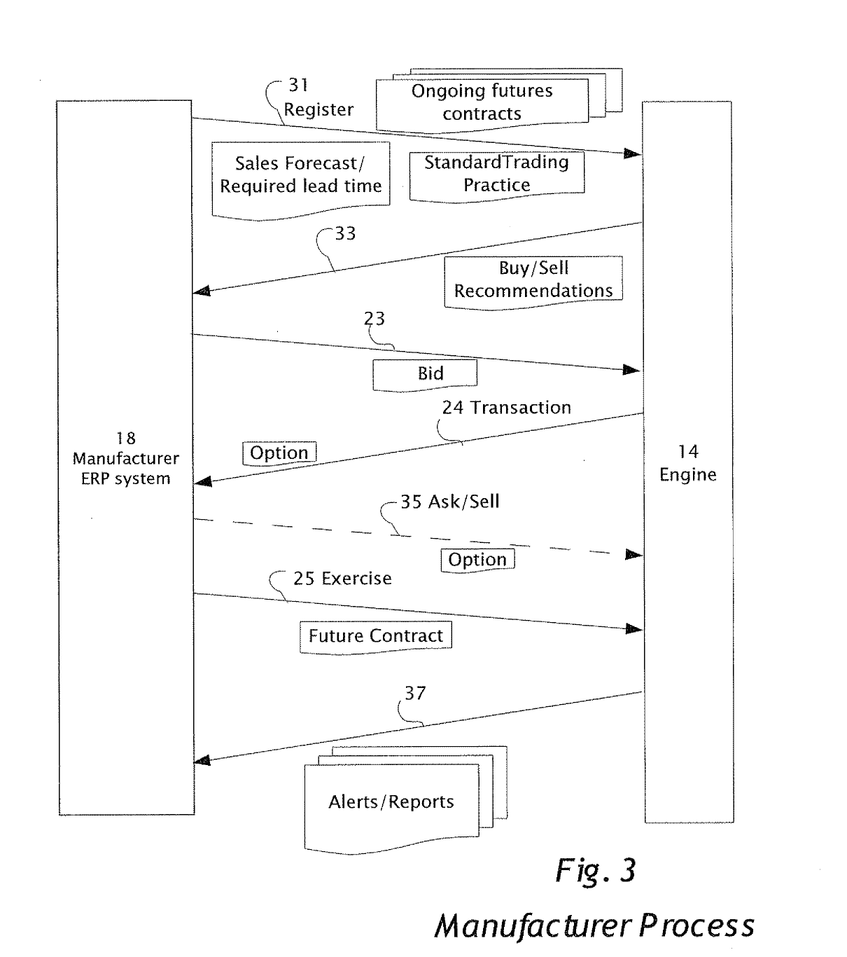

Reference is now made to FIG. 3 which illustrates in more detail interactions between application engine 14 and manufacturer ERP system 18, according to embodiments of the present invention. Typically a customer, e.g. manufacturer or distributor registers (step 31) with exchange 13. Registering (step 31) typically includes transferring information including expected sales forecast, and consequently based on the sales forecast the expected number of components required and lead time prior to delivery of the components. During registration (step 31), the manufacturer may transfer information to engine 14 regarding ongoing forecast for purchasing the components. The manufacturer receives instructions and is asked to confirm standard and/or regulated trading practice of options. Registration (step 31) may require the manufacturer to open a financial account for payment with exchange 13.

Based on the information providing during registration (step 31) and subsequent updates, engine 14 searches through options available and stored on exchange 13 and provides (step 33) as recommendations for suitable options to the manufacturer for bid (step 23). Typically during registration (step 31) the manufacturer (customer) agrees on acquiring an option, to a pay a fee or premium. The option premium is a source of income for the supplier. Recommendations for bid (step 23) by the customer are based on the customer's sales probability, required quantities and lead times. Returning to our example, in July YBM provides to engine 14 a sales forecast which requires 300 microprocessors by November with 80% confidence level and additional 200 microprocessors with 50% confidence level. Hence, all 500 microprocessor components are required at minimal lead time, about 3 months at a total cost of $1500 maximum. Engine 14 searches options listed exchange 13 that closely match YBM requirements and provides (step 33) the recommended listed options for bid by YBM. The customer/manufacturer typically places a bid (step 23) for one or more of the options listed on exchange 13 and in step 24 the option which typically receives the highest bid acquires the listed option. When the option is exercised (step 25) an agreement ensues, typically a future contract with terms, price and lead time to delivery as specified when the option was acquired (step 24).

The customer (manufacturer) may decide to sell the options held by listing the options held on exchange 13 with an ask price. The decision by the customer to sell options is based for instance on a prediction of manufacturer ERP system 18 that extra inventory is expected during a specific period. Another customer, registered with exchange 13 of the supplier may bid (step 23) for the options listed.

In addition, the customer (manufacturer ) may decide to list new options for bid for the excess inventory, with different terms, e.g. price and delivery, than the purchase options already held.

A listed option which is not acquired, or acquired but not exercised expires (step 28) on its expiration date. Engine 14 preferable generates (step 37) alerts to the manufacturer prior to expiration (step 28) of options held by the manufacture. Furthermore, engine 14 provides (step 37) report of activity periodically or upon request.

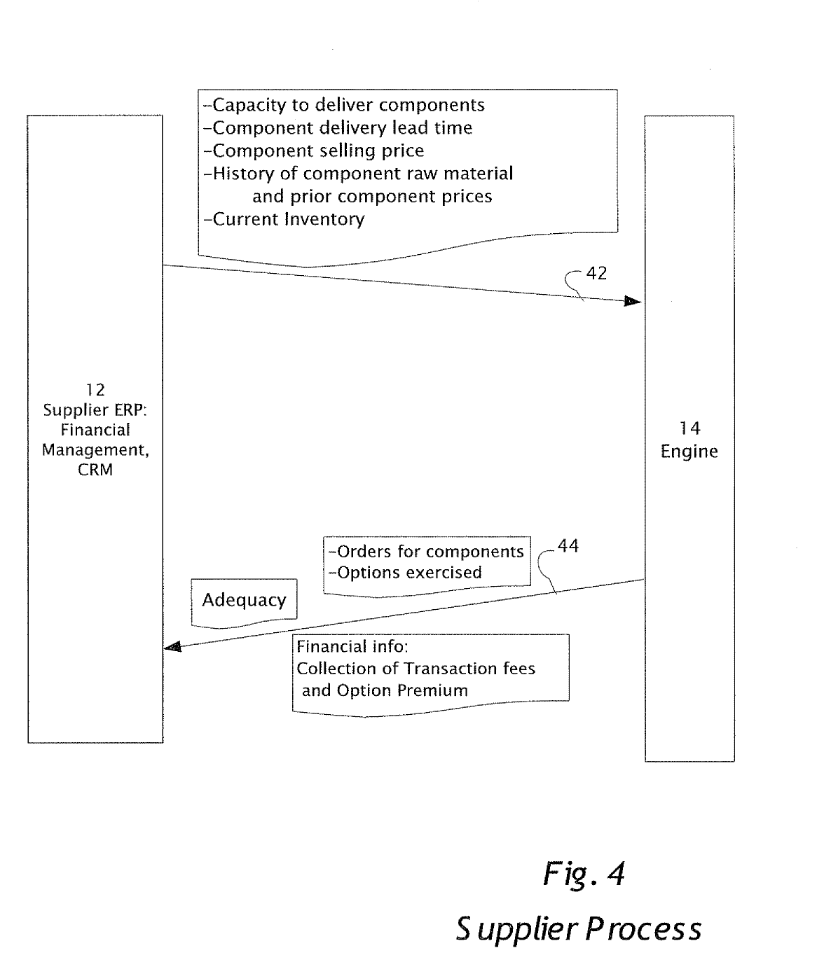

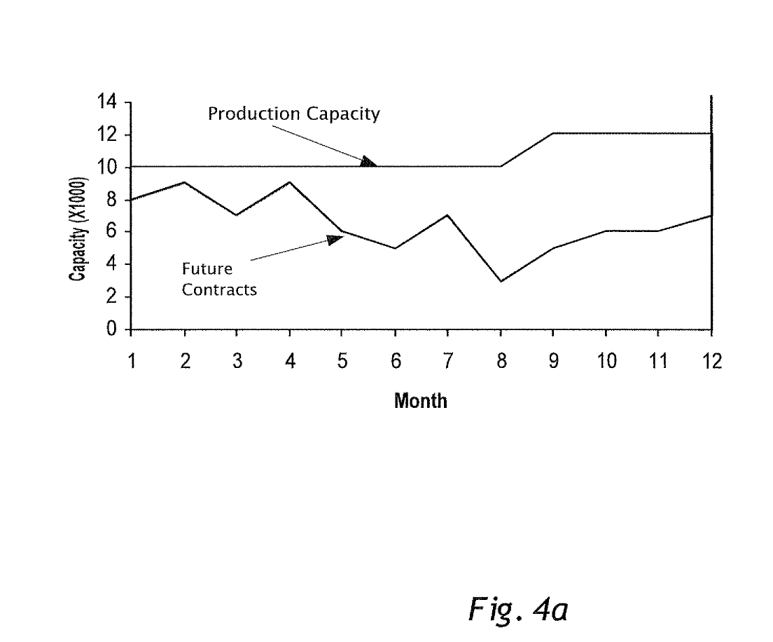

Reference is now made to FIG. 4 which illustrates schematically interactions between supplier ERP 12 and application engine 14, according to embodiments of the present invention. Supplier ERP 12 transfers (step 42) to application engine 14 information such as an updated capacity to produce components, component delivery lead time (after receipt of a production order), selling prices of the components, history of materials costs and prior component prices, and current inventory. Engine 14 transfers (step 44) to ERP 12 purchase orders for components which result from options after exercise 25 and financial data as follows. The exercise (step 25) of issued options effects a new future contract which is preferably input into ERP 12 as a new purchase order. Similarly, financial information such as records of transaction fees are input into ERP 12 from application engine 14.

Application engine 14 is a source of revenue for the supplier, and is preferably linked to the financial system of the supplier, such as through ERP 12 (or other financial system supplier is using). Income is preferably generated in a number of ways:
Purchase of options—payment of a fee (option premium) by customer to supplier for the option 20
Sale of options—payment of fee by customer to supplier for the option to sell excess inventory on exchange 13
Third party transaction—fees are paid by a third party, to use the exchange for buying/selling options for a transaction fee.
Engine 14 may be configured to provide adequacy information to supplier ERP 12 relative to the current state of options. Adequacy is based on a combination of expected inventory and expected capacity over time. The supplier may decide a level of inventory required to support outstanding options and weigh the risk of maintaining excess inventory against the risk of not being able to supply components.

Typically, capacity to produce components varies in time. An example of variation of production capacity of YNTEL is shown in the graph of FIG. 4A in which monthly production capacity is graphed monthly for a period of 12 months. Also graphed in FIG. 4A is the number of items for which there are outstanding future contracts. During the 12 month period shown, YNTEL has an overall increase in production capacity, e.g. an increase of 2000 units/month begins at the eighth month, and an overall decline in future contracts. In such a situation, YNTEL, without the benefit of the teachings of the present invention may decide to postpone the ramp up to increased production during the eighth month (and send its workers on extended holiday instead). According to the teachings of the present invention, the increase of production capacity and future contracts information is input by application engine 14 and used to determine a number of components for which to issue 22 options during the twelve month period.

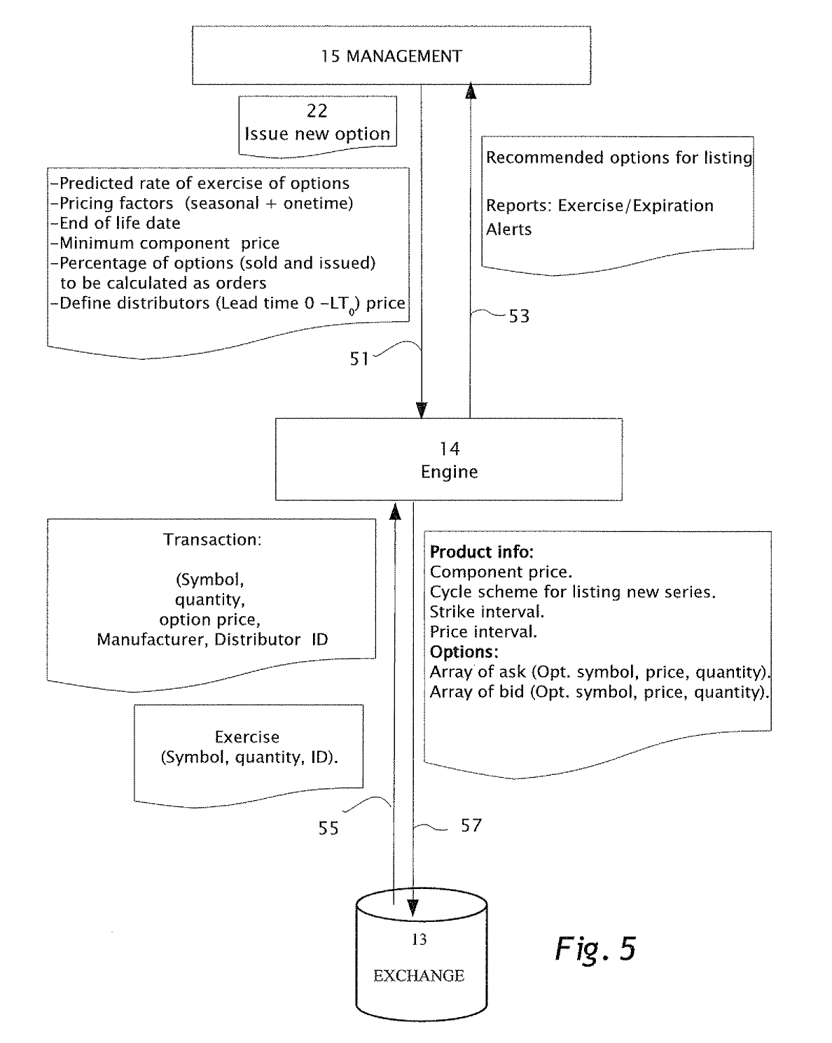

Reference is now made to FIG. 5 which illustrates schematically interactions of application engine 14 with exchange 13 and management module 15 respectively. Based on information available, e.g. ongoing production capacity, the number of units currently under order and/or under future contract, application engine 14 determines the number of components for which to issue 22 options. In step 53, a recommendation is input to issue a series of options for a specific number of components. The cost of the options may depend on economic factors such as trading history, calculated price volatility of the underlying components, and exchange activity. The recommendation is input as a record to management module 15 for review and decision ( by sales management of YNTEL) Using management module 15, a user (sales manager of YNTEL) may modify the terms of the recommendation or issue 22 options as recommended in step 53 by application engine 14. Management module 15 is used by sales personnel to input (step 51) into application engine 14 other pertinent economic data such as price factors, end-of-life date of the manufactured component, a minimum component price, and historical information regarding percentage of options exercised. Management module 15 is used by sales personnel to specify different conditions for different types of customers, for instance a manufacturer, e.g. YBM may receive better payment terms after exercise 25 than a third party stocking distributor.

Referring now to interactions between exchange 13 and engine 14, in step 55, a transaction record is transferred from exchange 13 to application engine 14 when a transaction 24 is effected. A transaction record typically includes a symbol representing the underlying components and supplier, a quantity of the underlying components, the price of the option, and an identifier of the customer, e.g. manufacturer or distributor. Similarly an exercise record is transferred from exchange 13 to application engine 14 when an exercise 25 is effected. An exercise record includes a symbol representing the supplier and component, strike price, a quantity and a customer identifier.

In step 57, data is transferred from application engine 14 to exchange 13. The data typically includes:

component data required for trading, a component price, typically the same price is provided by supplier ERP as the average component selling price,

rules/parameters for creating a new series of buy and/or sell options with different expiration date and lead time, a strike interval and a price interval (minimum price difference such as between ask and bid)

Typically, the total number of options listed by application engine 14 at any given time t may exceed the average capacity to deliver products during a time period including time t. It is expected that since only a portion of the sold options sold will be exercised and the remaining portion of unsold options expire. Hence, a fraction predicted level of exercise (LOEₜ) at time t is calculated as follows:

LOEₜ=[NumOfSoldOptionsₜ□□NumOfSoldOptionsₜ□Pₛₐₗₑ [symbol] □P_{exercise}

where Pₛₐₗₑ is the probability that an issued option is sold, and P_{exercise} is the probability that an option that has been sold will be exercised. Note that in a given series of options, the probability for exercise changes with the strike price.

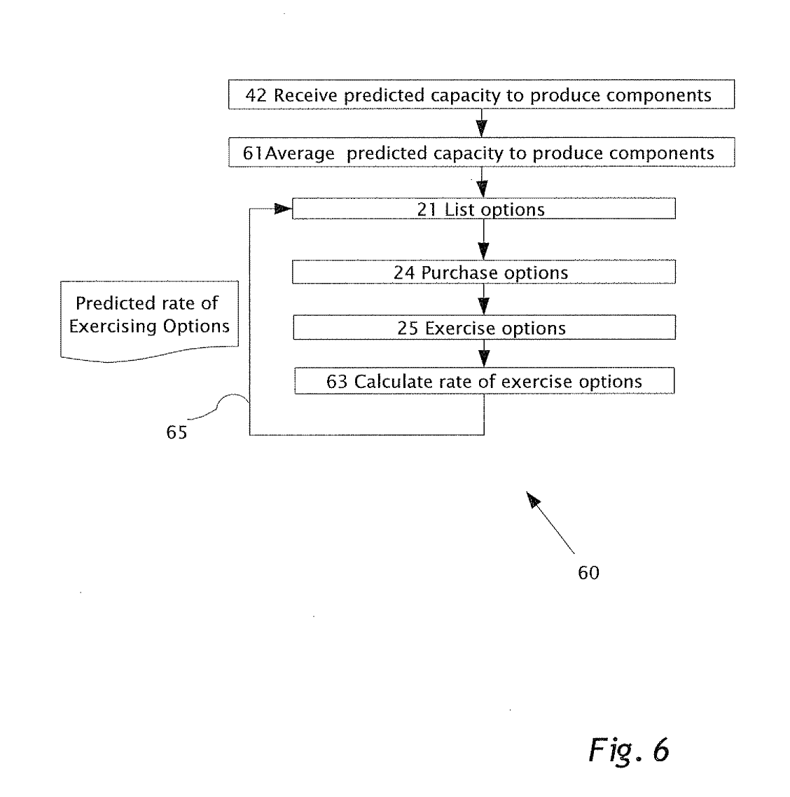

Reference is now made to FIG. 6 which includes a flow diagram of a process 60 for issuing options, according to embodiments of the present invention. In step 42 a predicted capacity to produce components by is received preferably from supplier ERP 12. The predicted capacity is averaged (step 61) over a period of time, e.g. 3 months. The averaged capacity is used to determine the conditions for listing (step 21) new options. Some of the options are purchased (step 24) by customers (e.g. manufacturer YBM) a portion of the purchased options are exercised, while the remaining portion expires. According to embodiments of the present invention, a rate of exercising (step 25) options is calculated and used to modify 65 the terms for listing (step 21) new options. Typically when the rate of exercise is low, modification (step 65) includes issuing (step 21) more options (each option cover predefined number of goods).

While the invention has been described with respect to a limited number of embodiments, it will be appreciated that many variations, modifications and other applications of the invention may be made.

What is claimed is:

1. A computer network operative between a supplier and at least one customer, wherein the supplier provides components used for manufacturing or resale by the at least one customer, the computer network comprising:
(a) an application running on a computer system of the computer network, wherein said application includes an interface to an enterprise resource planning (ERP) system of the supplier, wherein said application receives, as input from said ERP, a predicted capacity of the supplier for supplying the components; and
(b) a computerized exchange operatively attached to said application, wherein based on said predicted capacity, said supplier, using said application, issues a plurality of options on said computerized exchange, wherein the options are for buying the components in the future by the at least one customer, wherein each said option includes:
(i) an expiration date for exercising the option by the at least one customer owning the option,
(ii) a strike price for said buying a specific quantity of the components; and
(iii) a lead time for delivery of said specific quantity of the components, said lead time specified relative to the date of said exercising.

2. The computer network, according to claim 1, wherein said application sets the number of said options issued based on said predicted capacity of the supplier for supplying the components.

3. The computer network, according to claim 1, further comprising:
(c) a management module which inputs into said application a predicted probability of said exercising by the at least one customer.

4. The computer network, according to claim 3 wherein said application sets the number of said options issued based on said predicted probability of said exercising.

5. The computer network, according to claim 3, wherein said options are included in at least one series of options, wherein said application upon issuing said at least one series sets based on said predicted probability at least one parameter of said series, said at least one parameter selected from the group consisting of: an expiration date, and a lead time.

6. The computer network, according to claim 1, further comprising:
(c) an interface between said computerized exchange and an enterprise resource planning (ERP) system of said at least one customer, and when said ERP system of said at least one customer predicts a future excess inventory of at least one of said components, said interface providing at least one task selected from the group consisting of:
(i) an offer for sale of at least one of said options on said computerized exchange, and
(ii) an issue of at least one option of a second type, for buying back by the supplier from the at least one customer at least a portion of the components.

7. The computer network, according to claim 1, further comprising:
(c) an interface between said computerized exchange to an enterprise resource planning (ERP) system of said at least one customer, wherefrom said application receives as input a predicted purchasing requirement for purchasing said components, wherein said application searches through said options and provides based on said purchase requirement specific said options for bid by said at least one customer.

8. A method of doing business between a supplier and at least one customer, wherein the supplier provides components used for manufacturing or resale by the at least one customer, the method comprising:
(a) connecting to an enterprise resource planning (ERP) system of the supplier, and receiving as input from said ERP a predicted capacity of the supplier for supplying the components; and
(b) based on said predicted capacity, issuing a plurality of options by the supplier on an option exchange, wherein the options are for buying the components in the future by the at least one customer, wherein each said option includes:
(i) expiration date for exercising the option by the at least one customer owning the option,
(ii) a strike price for said buying a specific quantity of the components; and
(iii) a lead time for delivery of said specific quantity of the components, said lead time specified relative to the date of said exercising.

9. The method, according to claim 8, wherein said application sets the number of said options issued based on said predicted capacity of the supplier for supplying the components and on said predicted probability of said exercising.

10. The method, according to claim 8, further comprising the step of:
(c) inputting into said application a predicted probability of said exercising.

11. The method, according to claim 8, further comprising the step of:
(c) inputting into said ERP of said supplier a predicted probability of said exercising and the number of said options.

12. The method, according to claim 10, wherein said options include at least one series of options, wherein said application when issuing said at least one series sets based on said predicted probability at least one parameter of said series said at least one parameter selected from the group consisting of: an expiration date, and a lead time.

13. The method according to claims 10, wherein said application sets the number of said options issued based on said predicted probability of said exercising.

14. The method, according to claim 8, further comprising the step of
(c) upon predicting a future excess inventory of at least one of said components, performing at least one task selected from the group consisting of:
(i) offering for sale at least one of said options;
(ii) issuing by the supplier at least one option of a second type, for buying back by the supplier from the at least one customer at least a portion of the components.

15. The method, according to claim 8, further comprising the steps of:
(c) receiving as input a predicted requirement for purchasing of said components;
(d) searching through said options; and
(e) providing based on said purchase requirement specific said options for bid by said at least one customer.

16. A computer readable medium readable by a computer, tangibly embodying a program of instructions executable by the computer to perform a method of doing business between a supplier and at least one customer, wherein the supplier provides components used for manufacturing or resale by the at least one customer, the method steps according to claim 8.
